(19) United States
(12) Patent Application Publication
(10) Pub. No.: US 2011/0170817 A1
(43) Pub. Date: Jul. 14, 2011

(54) DEVICE FOR AXIAL FIXATION

(75) Inventors: Peter Niebling, Bad Kissingen (DE); Roland Langer, Schwanfeld (DE); Sebastian Lorenz, Rothenkirchen (DE)

(73) Assignee: SCHAEFFLER TECHNOLOGIES GMBH & CO. KG, Herzogenaurach (DE)

(21) Appl. No.: 13/119,837

(22) PCT Filed: Sep. 28, 2009
(86) PCT No.: PCT/EP2009/062496

§ 371 Date: Mar. 18, 2011

(30) Foreign Application Priority Data
Oct. 6, 2008 (DE) 10 2008 050 127.1

(51) Int. Cl. F16C 19/00; F16D 3/02; F16C 33/00

(52) U.S. Cl. 384/445; 403/164

(57) ABSTRACT

A device for axially fixing a rotatable part of a wheel bearing to a rotatable drive part of a drive shaft. The device provides a mounting auxiliary which enables inspection of the tooth position of a spur gearing. The device has a substantially cylindrical or ring-shaped attachment part and a locking element. Either the substantially cylindrical or ring-shaped attachment part is provided for attachment on the rotatable drive part, and the locking element is provided for locking to the rotatable wheel bearing part, or the substantially cylindrical or ring-shaped attachment part is provided for attachment to the rotatable wheel bearing part and the locking element is provided for locking to the rotatable drive part.

### FIELD OF THE INVENTION

The invention relates to a device for axially fixing a rotatable wheel bearing part of a wheel bearing with a rotatable drive part of a drive train.

A device of this type for axial fixation is used when mounting a wheel bearing with spur toothing. In the construction of a wheel bearing with spur toothing which is space saving in principle, it has to be ensured that the engagement of the wheel bearing-side spur toothing into the drive train-side spur toothing is guaranteed. As a rule, the wheel carrier prevents visual checking of this engagement of the two toothing systems, whereby it cannot be determined with conclusive certainty whether the teeth of the spur toothing systems lie on one another or engage into one another. The subsequent tightening of the central screw which fastens the wheel bearing to the articulated shaft also cannot make sure whether the connection is positively locking or has been produced only with a non-positive fit. In view of the torques which are transmitted by the spur toothing systems, an incorrectly installed wheel bearing unit leads during operation directly to destruction of the toothing systems and is to be avoided in all circumstances.

In order to avoid this type of incorrect mounting, no solution proposals are known up to now from the prior art.

The invention is based on the object of specifying a device which facilitates finding the correct tooth position of two spur toothing systems during wheel bearing mounting.

In a device of the type which is mentioned in the introduction, this object is achieved by virtue of the fact that the device for axial fixation has a substantially cylindrical or annular fastening part and a latching element, either the substantially cylindrical or annular fastening part being provided for fastening to the rotatable drive part and the latching element being provided for latching with the rotatable wheel bearing part or vice versa.

There is provision according to the invention for it to be possible for the rotatable drive part and the rotatable wheel bearing part to be connected to one another by the device for axial fixation before the central screw is tightened during the mounting of the wheel bearing. The device for axial fixation is therefore a mounting aid which is intended to ensure mutual engagement of a wheel bearing-side spur toothing system with a drive train-side spur toothing system. For this purpose, the substantially cylindrical or annular fastening part of the device is fastened either to the rotatable drive part or to the rotatable wheel bearing part. In a corresponding way, the latching element of the device for axial fixation is latched either with the rotatable wheel bearing part or with the rotatable drive part.

The rotatable drive part is a rotating component which is a constituent part of the drive train, to which the wheel bearing also has to be connected for drive torque transmission. For example, a shaft, components of a tripod joint, such as an articulation bell, or else different types of spacer rings therefore belong to the drive train.

The rotatable wheel bearing part is components of the wheel bearing which follow the movement of the wheel, such as an inner ring, a thrower ring of a sealing arrangement, a rolling rivet flange, a wheel hub or similar components.

In one advantageous embodiment, the latching element of the device for axial fixation can be latched only when a wheel bearing-side spur toothing system engages at least partially into a drive train-side spur toothing system. The engineer can therefore detect in a very easy way whether there is already an engagement. This is because fastening by the device for axial fixation will take place only when there is a (possibly partial) engagement of the spur toothing systems and the screw connection with the central screw can achieve the maximum positively locking fit at all. The engineer can be sure that the tightening of the central screw leads to the aim when axial fixing of the rotatable wheel bearing part with the rotatable drive part has been achieved by the device. The mounting process is therefore simplified and accelerated, which mounting process can be carried out more economically both on account of the quicker mounting and on account of the avoidance of damage.

In one advantageous embodiment, the device for axial fixation is provided for clasping the spur toothing or is itself clasped at least partially by said spur toothing and/or the inner ring of the wheel bearing. This results in the options that firstly the device also has a shielding or even sealing function with respect to the spur toothing or secondly material is saved on account of the small radial extent. If the device for axial fixation is provided for clasping the spur toothing, it is advantageous if, for example, a thrower ring of the sealing arrangement is combined with the device or is configured integrally with the latter.

In one advantageous embodiment, the fastening part of the device for axial fixation is fastened by press fit, clampings, latching or screwing to the rotating drive part or to the rotating wheel bearing part. As an alternative, an insertion of the fastening part in a groove of the corresponding rotating part is also possible. In principle, further other established fastening options can also be applied, which can be used both by the engineer and also in the factory.

In one advantageous embodiment, the latching element, during the mounting of the wheel bearing, is unloaded elastically in a latched state and is loaded elastically in an unlatched state. In this context, the state which the latching element assumes before mounting can be disregarded. During the mounting, however, a state of elastic loading of the latching element is caused by bringing together the rotating parts to be fixed. For example, the device could be held on the side of the articulation bell, an inner radius of the wheel hub maintaining elastic loading of the latching element until the desired position is reached and the latching element can pass over into its original shape (elastically unloaded state) and causes a latching action. Thanks to a stop or a retaining element, such as a groove, the latching element then ensures that an axial backward movement of the rotatable parts to be fixed is not possible. Furthermore, a continuation of the axial movements is prevented by the maximum engagement of the spur toothing systems. The axial fixation is therefore realized in both axial directions.

In a foremost embodiment, the device for axial fixation has a fastening part which for its part has the latching element, is connected integrally to the latter, can be connected to the latter or is identical with the latter. In addition to the latching element and the fastening part, a device for axial fixation can also have other parts with other functions. For example, the device can additionally have a seal or can be configured as a rotational speed sensor for a rotational speed measuring arrangement.

It is appropriate to also call a device for axial fixation a fixing element, as long as no parts other than the latching element and the fastening part are provided. In particular, when the fastening part and the latching element are connected integrally to one another, the fixing element reduces the number of components and simplifies the production of the device for axial fixation. It is particularly advantageous if the latching element and the fastening part are integrated into one another, or are identical to one another, because this type of simplification takes effect all the more.

In one advantageous embodiment, the latching element can be configured as a latching lug or as a latching ring. A plurality of latching lugs or a latching ring which is circumferentially interrupted optionally at points can be provided as a function of the desired retaining force. In principle, a plurality of latching lugs is appropriate if a uniform retaining force over the circumference is to be generated with relatively little material. In simpler embodiments, one or two latching lugs can certainly apply the necessary retaining force.

The latching ring and/or latching lug can advantageously prevent unloading, for example by means of a “barb principle” or can indicate the desired position merely on account of the shape which is assumed in the elastically unloaded state. If the latching ring or the latching lug realizes the barb principle, violent unlatching can lead to material damage of the device. In contrast to this, a fixing means based on the shape of the latching element will lead to a connection which can be reversed again by renewed elastic loading, in order to make renewed fixing possible, for example. This is advantageous, in particular, when the engineer has detected a mounting error at another location, which mounting error requires dismantling of the wheel bearing from the drive unit or a wheel bearing which has already been installed has to be replaced.

A device for axial fixation which clasps spur toothing advantageously has a seal for protecting the spur toothing systems. The device therefore additionally adopts a retaining function for, for example, a sealing lip and prevents the penetration of moisture and dirt particles into the engagement space of the spur toothing systems.

The device for axial fixation, in particular the latching lug or the latching ring, is advantageously provided for emitting a noise which serves as a detection signal for the engineer for the correct tooth position of the spur toothing systems. For example, a clicking noise can be realized by a correspondingly great prestressing force of the latching element or in another way and can therefore serve as an acoustic control signal.

In one advantageous embodiment, the device for axial fixation is connected integrally with the rotatable wheel bearing part or the rotatable drive part. A separate mounting step is therefore omitted which is provided for attaching the device to the rotating component. It is therefore conceivable, for example, that an integral configuration with an articulation bell leads to the wheel bearing merely having to be plugged on during the articulated shaft mounting of said wheel bearing before the central screw is tightened.

Advantageous embodiments and preferred developments of the invention can be gathered from the descriptions of the figures and/or the subclaims.

In the following text, the invention will be described and explained in greater detail using the exemplary embodiments which are shown in the figures, in which:

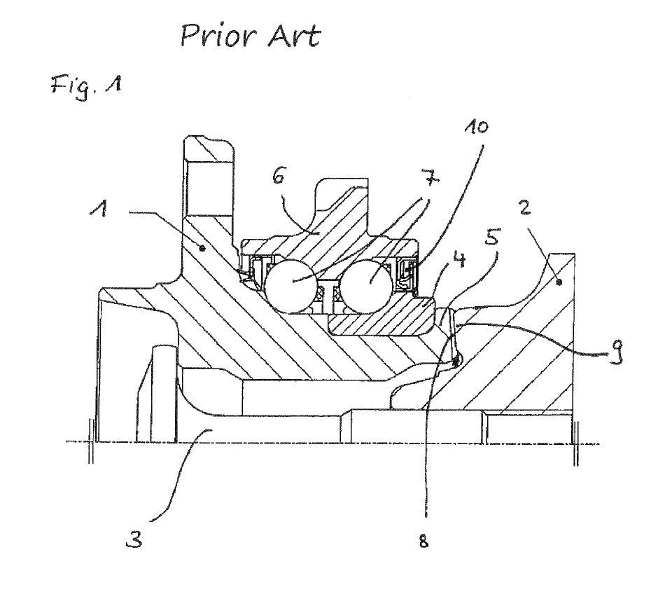

FIG. 1 shows a sectional view of a wheel bearing with spur toothing according to the prior art,

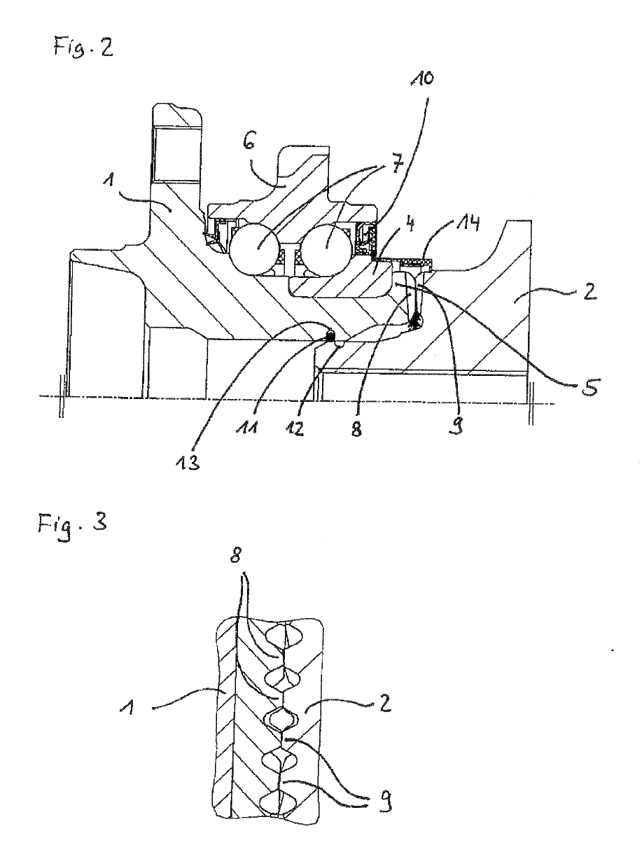

FIG. 2 shows a sectional view of a wheel bearing with spur toothing and a latching ring in an elastically loaded state,

FIG. 3 shows a detail of the spur toothing systems from FIG. 2 in a radial observation direction,

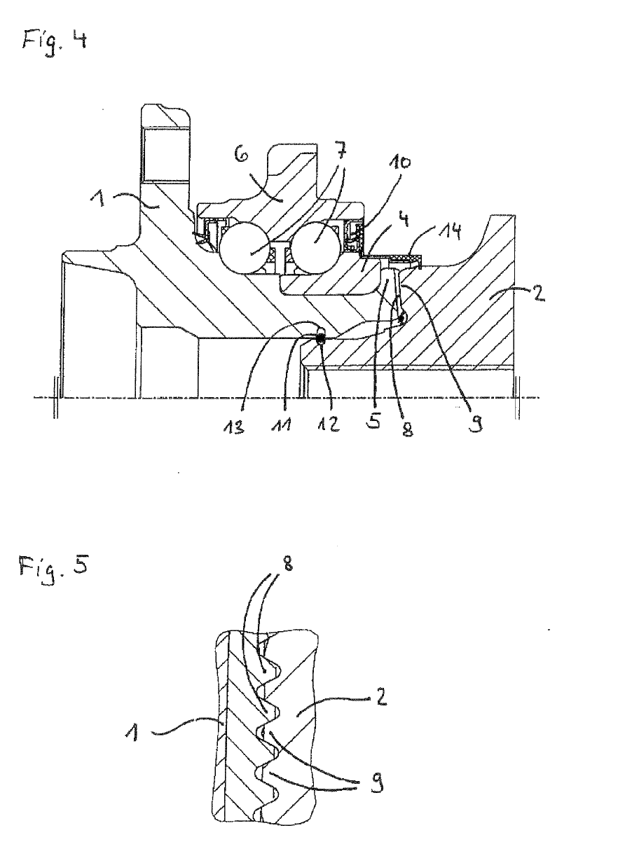

FIG. 4 shows a sectional view of the wheel bearing from FIG. 2 with the latching ring in an elastically unloaded state.

FIG. 5 shows a detail of the spur toothing systems from FIG. 4 in a radial observation direction,

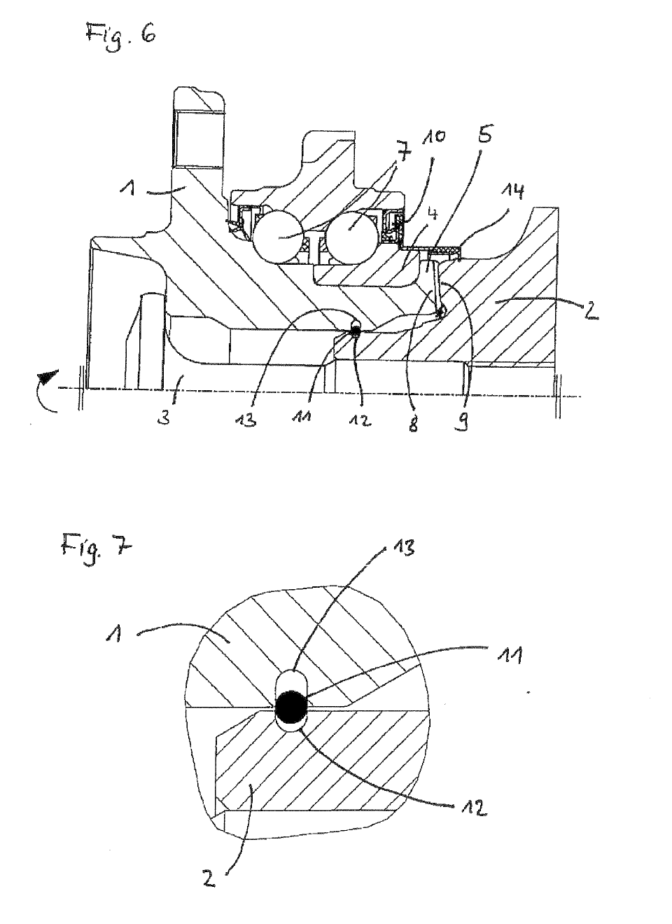

FIG. 6 shows a sectional view of the wheel bearing from FIG. 4 with a tightened central screw,

FIG. 7 shows an enlarged detail of the region around the latching ring from FIG. 6,

FIG. 8 shows a sectional view of a wheel bearing in a first mounting state with a first elastically loaded fixing element,

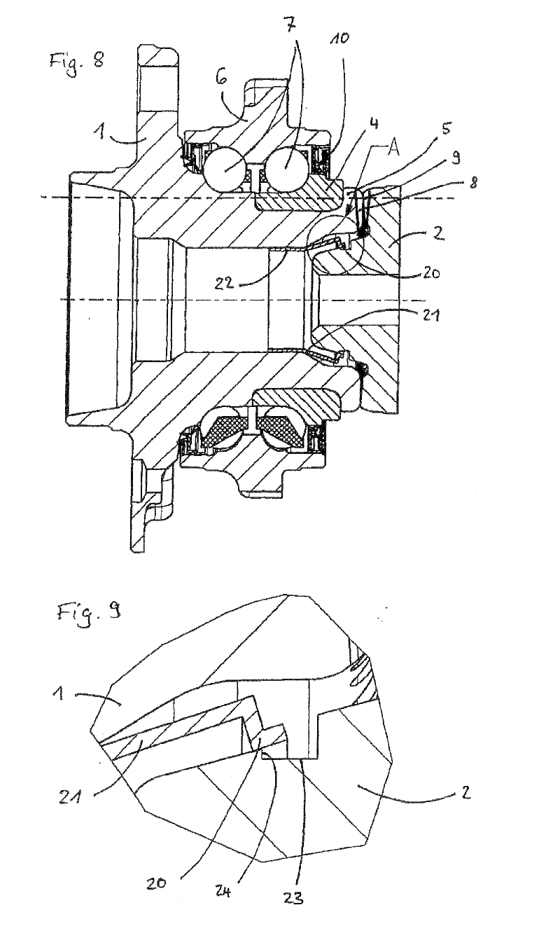

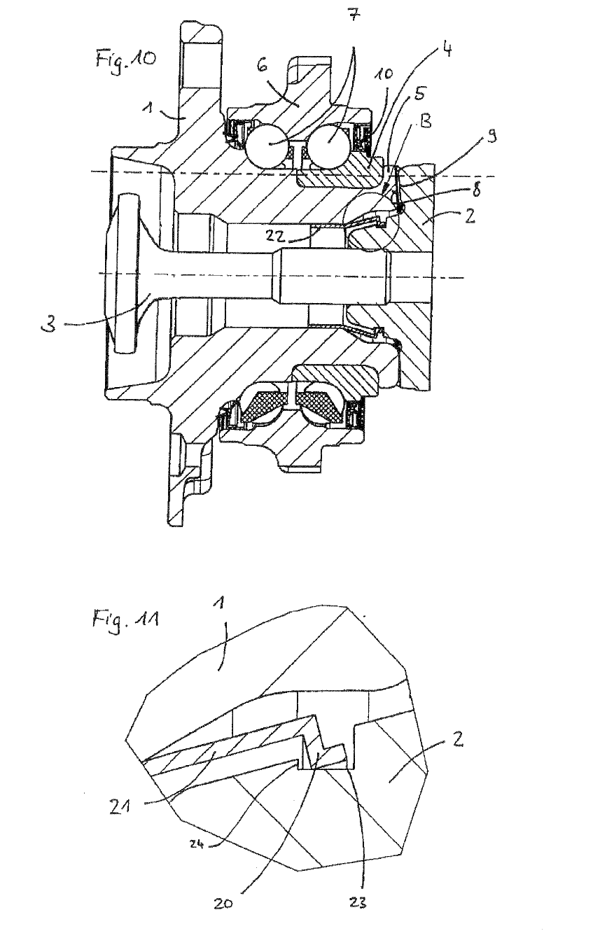

FIG. 9 shows an enlarged detail of the region around a latching lug of the first fixing element from FIG. 8,

FIG. 10 shows a sectional view of the wheel bearing from FIG. 8 in a second mounting state with the first elastically unloaded fixing element,

FIG. 11 shows an enlarged detail of the region around the latching lug of the first fixing element from FIG. 10,

FIG. 12 shows a sectional view of a second fixing element in the elastically unloaded state,

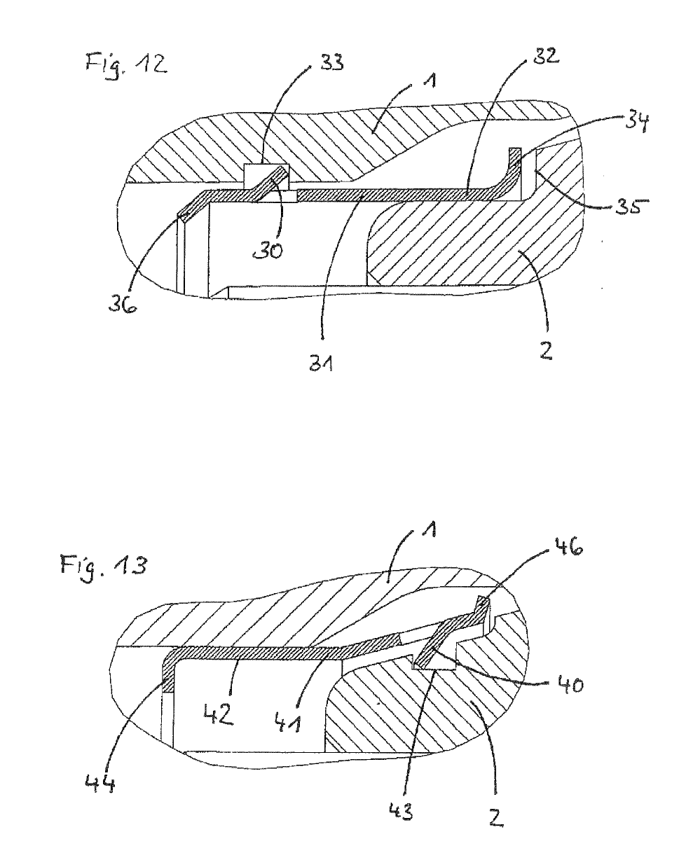

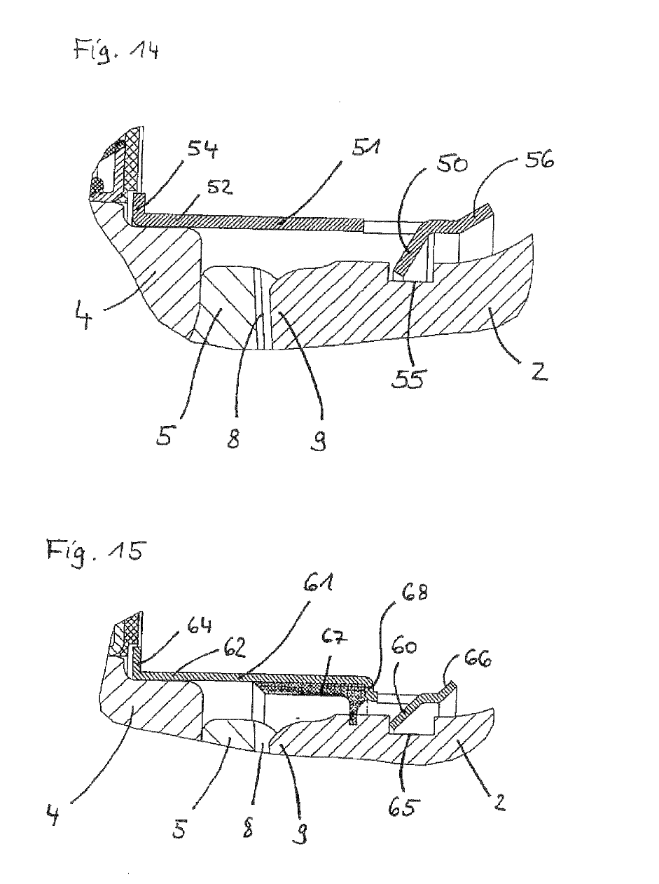

FIG. 13 shows a sectional view of a third fixing element in the elastically unloaded state,

FIG. 14 shows a sectional view of a fourth fixing element in the elastically unloaded state,

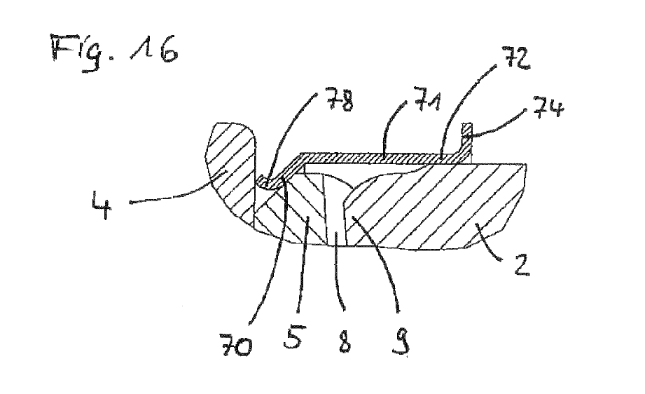

FIG. 15 shows a sectional view of a fifth fixing element in the elastically unloaded state, and

FIG. 16 shows a sectional view of a sixth fixing element in the elastically unloaded state.

FIG. 1 shows a sectional view of a wheel bearing with spur toothing 8 according to the prior art. The wheel bearing is an angular contact ball bearing with two rolling body rows 7, an outer ring 6 which is integrated with a fastening flange, and an inner ring 4. The spur toothing 8 is formed on a rolling rivet flange 5 and is in engagement with a spur toothing system 9 of an articulation bell 2, it also being possible for the spur toothing 9 to be called spur countertoothing. The wheel hearing is already completely mounted, that is to say the central screw 3 prestresses a wheel hub 1 via the spur toothing systems 8, 9 with the articulation bell 2.

During the installation operation, the problem which has already been discussed in the introduction comprises finding the correct tooth position in the spur toothing systems 8, 9. Neither the wheel bearing nor the articulation hell 2 provides any auxiliary positions to indicate a correct engagement of the spur toothing systems 8, 9. Since, during mounting, the radial view of the spur toothing systems 8, 9 is covered as a rule by the wheel carrier, the engineer is dependent solely on his installation skill.

FIG. 2 shows a sectional view of a wheel bearing with spur toothing 8 and a latching ring 11 in an elastically loaded state. The wheel bearing is situated in a first mounting state, in which there is not yet any engagement of the spur toothing 8 in the spur countertoothing 9 of the articulation bell 2.

Here, the latching ring 11 acts as a device for axial fixation which fixes a rotatable drive part, namely the articulation bell 2, with a rotatable wheel bearing part, namely the wheel hub 1. Furthermore, the latching ring 11 per se combines the annular fastening part and the latching element of the device for axial fixation in a single component.

A groove 13, in which the latching ring 11 lies in the elastically loaded state, is situated on a radial inner face of the wheel hub 1. The latching ring 11 can, for example, be composed of a metal or plastic and is interrupted at one point in the circumferential direction, with the result that it has two ends which lie opposite one another and are further away from one another in the elastically loaded state than in the elastically unloaded state. As shown in FIG. 2, in the first mounting state, the latching ring 11 is pressed into the groove 13 by a cylindrical projection of the articulation bell 2 and is widened radially in the process. The ends of the ring which lie opposite one another move away from one another during the widening operation.

The axial positions of the groove 13 and a groove 12 on the articulation bell 2 are adapted to one another in such a way that the spur toothing systems 8, 9 engage into one another when the grooves 13 and 12 lie radially opposite one another. If, however, they do not lie opposite one another, there is also not yet an engagement of the spur toothing systems 8, 9. In this first mounting state, the wheel bearing and the articulation bell 2 can be readily removed away from one another again, from which the engineer can detect that the engagement of the spur toothing systems 8, 9 has not yet taken place. If a separation of this type takes place, the latching ring 11 passes over again into an unloaded state which it had assumed before mounting.

The wheel bearing advantageously has a cover 14 which is fastened to the inner ring 4 and covers and, as a result, protects the spur toothing systems 8, 9. The cover 14 can be preinstalled because a direct view of the spur toothing systems 8, 9 is not necessary during the installation. As an alternative, a cover 14 of this type can also be combined or integrated with the sealing arrangement 10, in particular with its thrower ring.

FIG. 3 shows a detail of the spur toothing systems 8, 9 from FIG. 2 in a radial observation direction toward the rotational axis of the wheel bearing. The wheel bearing is situated in the first mounting state, in which no engagement of the spur toothing systems 8, 9 has yet been achieved. It can be seen that the teeth of the spur toothing systems stand on one another. If a central screw were tightened in this state, during operation both spur toothing systems 8, 9 would be released from the non-positive connection and damage one another.

FIG. 4 shows a sectional view of the wheel hearing from FIG. 2 with the latching ring 11 in an elastically unloaded state. The wheel bearing is situated in a second mounting state, in which the spur toothing systems 8, 9 engage into one another. At the same time, the grooves 12 and 13 have the same axial position and lie radially opposite one another. The latching ring 11 is therefore given additional space to pass into the elastically unloaded state. The radial extent of the latching ring 11 in the elastically unloaded state corresponds to an expansion of the latching ring 11, which expansion is necessary to lie partially in both grooves 12, 13. The latching ring 11 therefore fixes the relative position of the wheel hub 1 with respect to the articulation bell 2. It is decisive for this that there is also an engagement of the spur toothing 8 into the spur toothing 9 in said second mounting step.

The grooves 12, 13 advantageously provide the latching ring 11 with a certain axial play which makes it possible to screw the wheel huh 1 with respect to the articulation bell 2 with sufficient prestressing force by means of a central screw and to further deepen the engagement of the spur toothing systems 8, 9. Here too, however, a certain deformation or else destruction of the latching ring 11 has to be accepted, since said latching ring 11 has fulfilled its task of in principle indicating the engagement. A destruction of the latching ring 11 is even advantageous to the extent that said latching ring 11 is no longer in the way in the case of dismantling.

Before the mounting, the latching ring 11 can advantageously lie both in the groove 12 of the articulation bell 2 and also in the groove 13 of the wheel hub 1. This means that the articulation bell 2 and wheel hub 1 swap their roles (holding and deformation of the latching ring 11).

In one advantageous embodiment, the latching ring 11 is composed mainly of rubber or another elastic material and is uninterrupted. A latching ring 11 of this type achieves the same effect as an interrupted latching ring 11 made from metal, the fixing not being too strong and it optionally also being possible to reverse it readily. It is also advantageous that the rubber ring is lighter than the metal ring and therefore potentially helps to save fuel. Secondly, it is simpler to produce a clicking noise by means of the metal ring, which clicking noise clearly indicates the engagement of the spur toothing systems 8, 9 to the engineer.

FIG. 5 shows a detail of the spur toothing systems 8, 9 from FIG. 4 in a radial observation direction toward the rotational axis of the wheel bearing. In the second mounting state, the spur toothing systems 8, 9 engage into one another and make an operationally suitable tooth position possible after the tightening of the central screw.

FIG. 6 shows a sectional view of the wheel bearing from FIG. 4 with a tightened central screw 3.

FIG. 7 shows an enlarged detail of the region around the latching ring 11 from FIG. 6. It is advantageous if the latching ring 11 finds sufficient space in the groove 13 of the wheel huh 1, in order to lie with its volume completely in the wheel hub 1 in the case of elastic loading. As a result, the friction of the latching ring 11 on the articulation bell 2, or in general on components of the drive train, is minimized if the wheel bearing is situated in the first mounting state.

The groove 12 is advantageously too small to receive the latching ring 11 completely, which prevents, for example in the case of a latching ring 11 which is configured as a rubber ring, it being possible for said latching ring 11 to be received completely in the articulation bell 2. During the transition into the second mounting state, it is therefore ensured that the latching ring 11 still remains in operative connections with the wheel hub 1 and with its groove 13.

FIG. 8 shows a sectional view of a wheel bearing in a first mounting state with a first elastically loaded fixing element 21.

The device for axial fixation is configured as a fixing element 21 which has a fastening part 22 and a latching element 20. The fixing element 21 is provided for fixing a rotatable drive part, namely the articulation bell 2, to a rotatable wheel bearing part, namely the wheel hub 1.

The wheel bearing does not differ from the exemplary embodiment of FIGS. 2 to 7 with regard to the wheel hub 1, the outer ring 6, the rolling body rows 7, the sealing arrangement 10 and the inner ring 4. Furthermore, the wheel bearing arrangement has two spur toothing systems 8, 9, as are already previously known.

Before mounting, the fixing element 21 is fastened by means of the fastening part 22 in the inner side of the wheel hub 1 which faces the rotational axis. Here, the fixing element 21 can be pressed in or clamped in, that part of the fixing element 21 which carries the latching lug 20 enclosing an angle, in comparison with the cylindrical fastening part 22, in relation to the rotational axis of the wheel bearing and therefore acting as a positioning aid in a manner which assists during the positioning of the fixing element 21 in relation to the wheel hub 1, by it abutting the inner side of the wheel hub 1 during its axial movement.

The fixing element 21 is designed in such a way that it can be widened by the articulation bell 2 or by parts of the latter. This widening can be ensured by a longitudinal cut which runs axially through the entire fixing element 21, or by one or more cuts which are oriented in the axial direction merely in the vicinity of the latching lug 20. The latching lugs 20 can therefore be separated from one another in the circumferential direction if the widening takes place by the articulation hell 2.

As an alternative, the fixing element 21 can also be produced with a correspondingly elastic material, for example plastic, with which an annular latching lug would also be realized, that is to say therefore a snap-in ring or latching ring.

During the widening of the fixing element 21, the articulation bell 2 or a part of the latter exerts force on the latching lugs 20 and presses them apart from one another. This can be assisted by a corresponding shape of the articulation bell 2, for example by rounded corners of the latter.

The elastic loading of the fixing element 21 can additionally be assisted by a suitable material selection. The fixing element 21 can be composed at least partially of plastic, metal or similar materials and can optionally also have parts made from rubber.

FIG. 9 shows an enlarged detail of the region around the latching lug 20 of the first fixing clement 21 from FIG. 8. In particular, the groove 23 of the articulation bell 2 belongs to this, which groove 23 is provided for snapping in the latching lug 20. The radial faces of the groove 23 are oriented at right angles to one another and afford sufficient space for the latching lug 20 to snap in, and additionally a retaining face 24 which prevents axial removal of the parts to be fixed.

FIG. 10 shows a sectional view of the wheel bearing from FIG. 8 in a second mounting state with the first elastically unloaded fixing element 21.

The fixing element 21 has passed into the elastically unloaded state and fixes the wheel hub 1 with the articulation bell 2. The spur toothing systems 8, 9 are in engagement, the central screw 3 also having been placed already. The mounting of the wheel hearing is therefore concluded.

In particular, the fact is advantageous in this embodiment that, in the case of a low clamping force of the fastening element 22, dismantling of the wheel bearing is also possible, without damaging the fixing element 21 which is latched in. Said fixing element 21 is held during dismantling by the articulation hell 2 or its groove 23 and is pulled out of the interior of the wheel hub 1.

FIG. 11 shows an enlarged detail of the region around the latching lug 20 of the first fixing element 21 from FIG. 10.

FIG. 12 shows a sectional view of a second fixing element 31 in the elastically unloaded state. The fixing element 31 is distinguished by a fastening part 32 which is fastened or clamped on the articulation hell 2 by press fit. In addition, the fixing clement has an insertion aid 36 which assists guiding it together with the wheel hub 1.

The basic shape of the fixing element 31 is a cylindrical shape, from which merely the insertion aid 36, the latching lug 30 and a radial projection 34 deviate. A plurality of latching lugs 30 are advantageously attached which have been punched partly out of the fixing element 31 and have been subsequently bent out. This saves material and opens up the option to fix the number of lugs and also their circumferential extent as desired. In order to prevent tilting, at least the attachment of two latching lugs 30 which lie opposite one another is appropriate. A self centering action can be achieved with three latching lugs 30, which self centering action further improves the mounting properties of the fixing element 31. Moreover, a plurality of latching lugs 30 which are arranged in the circumferential direction can be provided.

The radial projection 34 can be used to position the fixing element 31 with respect to the articulation bell 2, the stop 35 serving as reference. There can be provision for a spacer ring to be provided between the radial projection 34 and the stop 35 or for the correct spacing to be maintained in another way, for example by remeasuring. It is also conceivable that the radial projection 34 is to bear against the stop 35.

FIG. 13 shows a sectional view of a third fixing element 41 in the elastically unloaded state. The wheel hub 1 and the articulation bell 2 are already fixed to one another by the latching in of the latching lug 40. The fixing element 41 also has a fastening part 42 which opens into a radial projection 44 which can he used as insertion aid. The projection 46 is also to be seen in a similar way when the intention is to place the fixing element 41 on the articulation bell 2.

FIG. 14 shows a sectional view of a fourth fixing element 51 in the elastically unloaded state. This is a fixing element 51 which is provided for clasping the two spur toothing systems 8, 9 and therefore also covers all the parts of the torque transmitting connection which are sensitive to rust. The inner ring 4 and the rolling rivet flange 5 also belong to these.

The radial projection 54 is advantageously used for connecting to a sealing arrangement or for spacing parts of the inner ring 4 or the sealing arrangement. The latching lugs 50 snapped into the groove 55 when the fixing element 51 which clearly fastens the fastening region 52 to the inner ring 4 is pushed over the articulation bell 2. The projection 56 serves as insertion aid.

FIG. 15 shows a sectional view of a fifth fixing element 61 in the elastically unloaded state. The fixing element 61 corresponds substantially to the fixing element 51 of the preceding figure. In contrast to the latter, the fixing element 61 has a seal 67 which ensures by way of a sealing lip that no moisture can pass to the spur toothing systems 8, 9 or the rolling rivet flange or the inner ring 4.

The radial projection 64 advantageously extends further radially than the radial projection 54, whereby improved collecting of spray water and its circumferential discharging are ensured.

FIG. 16 shows a sectional view of a sixth fixing element 71 in the elastically unloaded state. The fixing element 71 has a fastening part 72 which is provided for placing on the articulation bell 2 and merges into a radial projection 74. The latching lug 70 is provided for latching in an annular notch between the rolling rivet flange 5 and the inner ring 4 and has an insertion aid 78 which is configured as a partial rounded portion.

The sixth fixing element 71 can also be configured with a sealing lip (not shown) which bears either against the inner ring 4 or against the rolling rivet flange 5, in order to protect the toothing systems 8, 9 against moisture and dirt particles.

In summary, the invention relates to a device for axially fixing a rotatable wheel bearing part of a wheel hearing with a rotatable drive part of a drive train. A mounting aid is to be provided which makes checking of the tooth position of the participating spur toothing systems possible. This is solved by the fact that the device for axial fixing has a substantially cylindrical or annular fastening part and a latching element, either the substantially cylindrical or annular fastening part being provided for fastening to the rotatable drive part and the latching element being provided for latching with the rotatable wheel bearing part, or the substantially cylindrical or annular fastening part being provided for fastening to the rotatable wheel bearing part and the latching element being provided for latching with the rotatable drive part.

### LIST OF DESIGNATIONS

A A Enlarged Region
B Enlarged Region
1 Wheel Hub
2 Articulation Bell
3 Central Screw
4 Inner Ring
5 Rolling Rivet Flange
6 Outer Rings
7 Rolling Body Rows
8 Spur Toothing Of The Wheel Hub
9 Spur Toothing Of The Articulation Bell
10 Sealing Arrangement
11 Latching Ring
12 Groove
13 Groove
14 Cover
20 Latching Lug
21 Fixing Element
22 Cylindrical Fastening Part
23 Groove
24 Retaining Face
30 Latching Lug
31 Fixing Element
32 Cylindrical Fastening Part
33 Groove
34 Radial Projection
35 Stop
36 Insertion Aid
40 Latching Lug
41 Fixing Element
42 Cylindrical Fastening Part
43 Groove
44 Insertion Aid
46 Projection
50 Latching Lug
51 Fixing Element
52 Cylindrical Fastening Part
54 Radial Projection
55 Groove
56 Projection
60 Latching Lug
61 Fixing Element
62 Cylindrical Fastening Part
64 Radial Projection
65 Groove
66 Projection
67 Seal
70 Latching Lug
71 Fixing Element
72 Fastening Part
74 Radial Projection
78 Insertion Aid

1-15. (canceled)

16. A device for axially fixing a rotatable wheel bearing part of a wheel hearing with a rotatable drive part of a drive train, comprising:
a substantially cylindrical or annular fastening part for fastening to the rotatable drive part or for fastening to the rotatable wheel bearing part; and
a latching element for latching with the rotatable wheel bearing part or for latching with the rotatable drive part.

17. The device as claimed in claim 16, wherein the fastening part fastens by press fit, clamping, latching, screwing or is inserted in a groove.

18. The device as claimed in claim 16, the latching element, wherein the latching element is unloaded elastically in a latched state and is loaded elastically in an unlatched state when the wheel bearing is mounted.

19. The device as claimed in claim 16, wherein the fastening part is connected integrally to the latching element, is capable of being connected to the latching element or is identical to the latching element.

20. The device as claimed in claim 16, wherein the latching element is a snap-in lug, a snap-in ring, a latching lug or a latching ring.

21. The device as claimed in claim 16, wherein the wheel bearing part has a spur toothing and the rotatable drive part has a spur toothing and the device clasps the spur toothing of the wheel bearing part and the spur toothing of the rotatable drive part together, forming a spur toothing system.

22. The device as claimed in claim 21, further comprising a seal for protecting the spur toothing system.

23. The device as claimed in claim 16, wherein audible noise is generated during the latching of the latching element.

24. The device as claimed in claim 16, wherein the rotatable wheel bearing part or the rotatable drive part are configured integrally with the device.

25. A wheel bearing arrangement, comprising:
a rotatable wheel bearing part; and
a device for axial fixation of a rotatable wheel bearing part of a wheel bearing with a rotatable drive part of a drive train, comprising a substantially cylindrical or annular fastening part for fastening to the rotatable drive part or for fastening to the rotatable wheel bearing part; and a latching element for latching with the rotatable wheel bearing part or for latching with the rotatable drive part.

26. The wheel bearing arrangement as claimed in claim 25, wherein the rotatable wheel hearing part is a part of a sealing arrangement, an inner ring, a rolling rivet flange and/or a wheel hub.

27. The wheel bearing arrangement as claimed in claim 25, wherein the rotatable drive part is a ring, an articulation bell or is connectable to the ring or the articulation bell.

28. The wheel bearing arrangement as claimed in claim 25, further comprising a wheel bearing-side spur toothing system and a drive train-side spur toothing system, wherein the latching element is latched only when the wheel hearing-side spur toothing system engages at least partially into the drive train-side spur toothing system.

29. The wheel bearing arrangement as claimed in claim 26, wherein the wheel bearing part has a spur toothing and the rotatable drive part has a spur toothing and the device clasps the spur toothing of the wheel bearing part and the spur toothing of the rotatable drive part together, forming a spur toothing system, or the device is clasped, at least partially, by the spur toothing and/or the inner ring of the rotatable wheel bearing.

30. A rotatable component, comprising:
a stop and/or a groove for latching the rotatable component with a device for axial fixation of a rotatable wheel hearing part of a wheel bearing with a rotatable drive part of a drive train, comprising a substantially cylindrical or annular fastening part for fastening to the rotatable drive part or for fastening to the rotatable wheel bearing part; and a latching element for latching with the rotatable wheel bearing part or for latching with the rotatable drive part.
